(19) United States
(12) Patent Application Publication
(10) Pub. No.: US 2012/0252340 A1
(43) Pub. Date: Oct. 4, 2012

(54) AIR CONDITIONING APPARATUS

(75) Inventors: Patrick J. Gannon, Livonia, MI (US); James Stander, West Bloomfield, MI (US); Daniel J. DiGasbarro, Oxford, MI (US); David A. Korenchuk, Royal Oak, MI (US); Masahide Honda, Gamagori City (JP)

(73) Assignee: DENSO INTERNATIONAL AMERICA, INC., Southfield, MI (US)

(21) Appl. No.: 13/152,687

(22) Filed: Jun. 3, 2011

Related U.S. Application Data
(60) Provisional application No. 61/469,513, filed on Mar. 30, 2011.

(51) Int. Cl. B60H 1/00; F25B 49/02

(52) U.S. Cl. 454/75; 62/228.1

(57) ABSTRACT

An air-conditioning apparatus for a vehicle cabin has an air-conditioning case defining a plurality of air intake modes. The plurality of air intake modes includes an ambient air intake mode, and a double-layered air intake mode. The double-layered air intake mode supplies ambient air to a front side of the vehicle cabin via a front air passage, and supplies a recirculation air from the vehicle cabin to the rear side of the vehicle cabin via a rear air passage. The controller controls the air-conditioning case to switch the air intake mode from the double-layered air intake mode to the ambient air intake mode, when an evaporator temperature falls below a first threshold value.

### CROSS-REFERENCE TO RELATED APPLICATIONS

This application claims the benefit of U.S. Provisional Application No. 61/469,513, filed on Mar. 30, 2011. The entire disclosure of the above application is incorporated herein by reference.

### FIELD

The present disclosure relates to an air conditioning apparatus for a vehicle.

### BACKGROUND

The laid-open, unexamined Japanese patent application No. JP10-203135 discloses an air-conditioning apparatus, which switches its intake air mode between a single air intake mode and a double-layered air intake mode. In the double-layered air intake mode, the air-conditioning apparatus intakes ambient air from an outside of the vehicle and simultaneously, the air-conditioning apparatus intakes recirculated air from inside of the vehicle cabin.

Yet, in the double-layered air intake mode, the first air passage is configured to provide the ambient air to an upper part of a driver seat, and the second air passage is configured to provide the recirculated air to a lower part of the driver seat. Still yet, the air-conditioning apparatus is equipped with a first thermistor disposed in a first air passage and a second thermistor disposed in a second air passage. The first and second thermistors are used to control a compressor.

Since the air-conditioning apparatus described in JP10-203135, only provides conditioned air to the front seat side of the vehicle cabin, and the recirculated airflow flowing in the second air passage is only provided to the lower part of the driver seat, the air-conditioning apparatus switches its intake air mode based on a target temperature and air distribution mode.

If a single air-conditioning apparatus is configured to simultaneously provide air to the front seat side of the vehicle cabin and a rear seat side of the vehicle cabin, the recirculated airflow of the double-layered air intake mode, may be provided to a rear passenger seat, not only lower part of the rear passenger seat, but also upper part of the rear passenger seat.

### SUMMARY

The present disclosure describes the air-conditioning apparatus being controlled to switch its intake air mode between the double-layered air intake mode and the single air intake mode, based on the temperature of the evaporator.

More specifically, the present disclosure describes an air-conditioning apparatus for a vehicle cabin comprising an air-conditioning case defining a plurality of air intake modes, the plurality of air intake modes includes an ambient air intake mode mainly introducing ambient air from an outside of the vehicle cabin, and a double-layered air intake mode simultaneously introducing the ambient air and recirculation air from an inside of the vehicle cabin, an evaporator accommodated in the air-conditioning case, a first thermistor configured to detect the temperature of the evaporator, and a controller for controlling the air-conditioning case. The double-layered air intake mode supplies ambient air to a front side of the vehicle cabin via a front air passage, and supplies a recirculation air from the vehicle cabin to the rear side of the vehicle cabin via a rear air passage, and the controller controls the air-conditioning case to switch the air intake mode from the double-layered air intake mode to the ambient air intake mode, when an evaporator temperature detected by the first thermistor falls below a first threshold value.

Another aspect of the present disclosure is, a second thermistor configured to detect temperature of the evaporator in the front air passage. The first thermistor is configured to detect temperature of the evaporator in the rear air passage, wherein the controller stops a compressor, which constitutes a refrigeration cycle with the evaporator when the evaporator temperature detected by the second thermistor falls below a second threshold value.

Yet another aspect of the present disclosure is, the rear air passage supplies the recirculation to an upper part of a rear passenger seat. Still yet another aspect of the present disclosure is, a first blower configured to provide airflow in the air-conditioning case, and a second blower configured to provide airflow in the rear air passage. The air-conditioning case defines dividing wall, which divides the front air passage and the second air passage, and a part of the dividing wall moves when the controller controls the air-conditioning case to switch the air intake mode.

Another aspect of the present disclosure is a heating heat exchanger accommodated in the air-conditioning case, the heating heat exchanger penetrates the dividing wall, and a pair of air-mixing doors are disposed between the evaporator and the heating heat exchanger. Wherein, one of the air-mixing doors is disposed in the front air passage, and the other one of the air-mixing doors is disposed in the rear air passage.

Further areas of applicability will become apparent from the description provided herein. It should be understood that the description and specific examples are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic cross sectional view of an air-conditioning apparatus in a vehicle in the present disclosure;

FIG. 2 is a cross sectional view showing detailed shape of the air conditioning case in the double-layered air intake mode, distributing the conditioned air to upper side of seats;

FIG. 3 is a cross sectional view showing detailed shape of the air conditioning case in the ambient air intake mode, distributing the conditioned air to upper side of seats;

FIG. 4 is a cross sectional view showing detailed shape of the air conditioning case in the double-layered air intake mode, distributing the conditioned air to upper and lower side of seats;

FIG. 5 is a cross sectional view showing detailed shape of the air conditioning case in the ambient air intake mode, distributing the conditioned air to upper and lower side of seats;

FIG. 6 is a cross sectional view showing detailed shape of the air conditioning case in the double-layered air intake mode, distributing the conditioned air to lower side of seats;

FIG. 7 is a cross sectional view showing detailed shape of the air conditioning case in the ambient air intake mode, distributing the conditioned air to lower side of seats, and

FIG. 8 is a flowchart depicting a control method for the air-conditioning case in the present disclosure.

Corresponding reference numerals indicate corresponding elements throughout the several views of the drawings.

### DETAILED DESCRIPTION

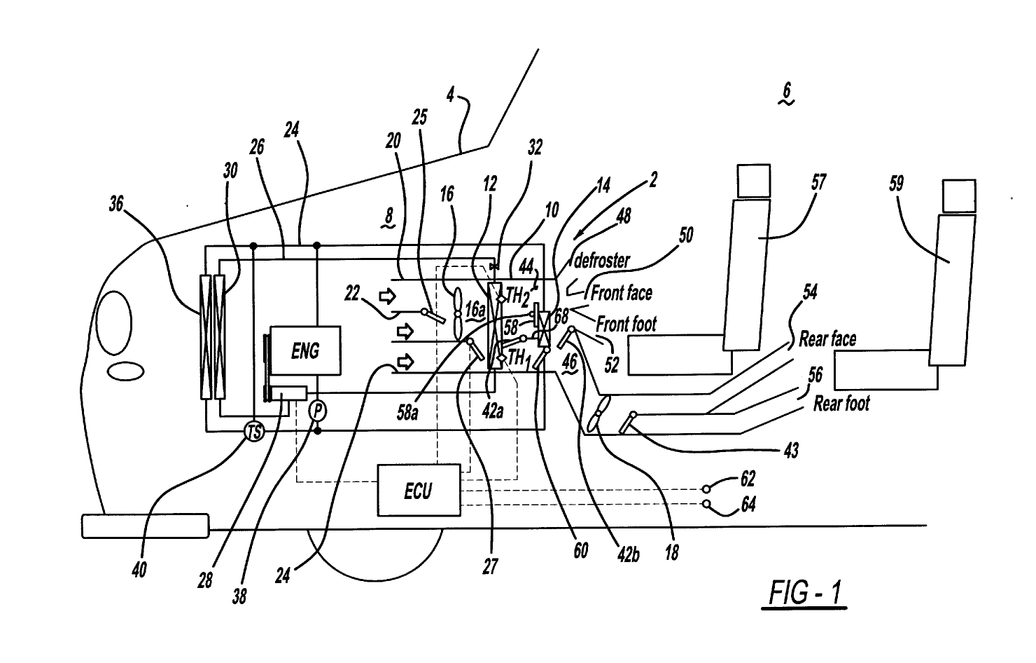

The preferred embodiments will now be described more fully with reference to FIGS. 1-8 of the accompanying drawings.

FIG. 1 is a schematic cross sectional view of an air-conditioning apparatus 2 in a vehicle 4 in the present disclosure. The air-conditioning apparatus 2 is disposed between a vehicle cabin 6 and an engine compartment 8 in the vehicle 4. The air-conditioning apparatus 2 comprises an air-conditioning case 10, an evaporator 12, an heating heat exchanger 14, a first blower 16, second blower 18, and a plurality of doors 25, 27, 42a, 42b, 43, 58, 60, and 66a-66c accommodated in the air-conditioning case 10.

The air-conditioning case 10 defines an ambient air inlet 20, a first recirculation air inlet 22, and second recirculation air inlet 24. The plurality of doors may include an ambient-recirculation air switching door 25, and an intake mode switching door 27. The ambient air inlet 20 is configured to introduce ambient air from an outside of the vehicle cabin 6 to the air-conditioning case 10. The first and second recirculation air inlet 22 and 24 are configured to introduce recirculation air from the vehicle cabin 6. The ambient-recirculation air switching door 25 configured to alternatively open the ambient air inlet 20 or the first recirculation air inlet 22. The intake mode switching door 27 opens and closes the first recirculation air inlet 22.

The air-conditioning case 10 also defines a plurality of air intake modes. The plurality of air intake modes may include an ambient air intake mode mainly introducing ambient air from the outside of the vehicle cabin 6, and a double-layered air intake mode simultaneously introducing the ambient air and recirculation air from an inside of the vehicle cabin 6. In the ambient air intake mode, the ambient-recirculation air switching door 25 closes the first recirculation air inlet 22, and opens the ambient air inlet 20. Also, in the ambient air intake mode, the intake mode switching door 27 opens the second recirculation air inlet 24. Thus, intake mode switching door 27 allows the airflows to be in parallel or series. When rear blower is turned off, the intake mode switching door 27 may close the second recirculation air inlet 24.

The evaporator 12 is disposed downstream side of the intake mode switching door 27. The evaporator 12 is a cooling heat exchanger. The evaporator 12 constitutes a refrigeration cycle 26 with a compressor 28, a condenser 30, and an expansion valve 32. The compressor 28 is configured to take in gas phase refrigerant from the evaporator 12, and compress the gas phase refrigerant. The condenser 30 is configured to cooling compressed refrigerant discharged from the compressor 28. The expansion valve 32 is configured to decompress the cooled refrigerant from the condenser 30.

The heating heat exchanger 14 is disposed downstream side of the evaporator 12. In this embodiment, the heating heat exchanger 14 is a heater core. The heater core constitutes an engine cooling cycle 34 with a radiator 36, a water pump 38, and a thermostat 40. The heater core utilizes waste heat of an internal combustion engine, but the heating heat exchanger 14 may not be limited to a heater core. The heating heat exchanger 14 includes a radiator 36 for other waste heat utilizing systems such as a battery cooling circuit, or other electrical equipments.

The plurality of doors may further include rear airflow amount control doors 42a, 42b, and a rear distribution mode door 43. In this embodiment, there are two rear airflow amount control doors 42a, 42b. One of the rear airflow amount control doors 42a is disposed upstream side of the heating heat exchanger 14. The other one of the rear airflow amount control doors 42b is disposed downstream side of the heating heat exchanger 14. In the double-layered intake mode, the air-conditioning case 10 and the rear airflow amount control doors 42a, 42b are a part of a dividing wall 68 dividing a front air passage 44, and a rear air passage 46. In the double-layered intake mode, airflow streams coming from the ambient air inlet 20, flow into the front air passage 44, and airflow streams coming from the second recirculation air inlet 24, flow into the rear air passage 46. The front air passage 44, and the rear air passage 46 provide parallel airflow streams, and the evaporator 12 and the heating heat exchanger 14 extended over both air passages 44 and 46. The airflow passing through the rear air passage 46 is divided by the rear distribution mode door 43.

The air-conditioning case 10 further defines a plurality of air outlets. Air outlets located at downstream end portion of the front air passage 44 may define a defroster outlet 48, a front face outlet 50, and a front foot outlet 52. Air outlets located at downstream end portion of the rear air passage 46 may define a rear face outlet 54 and a rear foot outlet 56.

The defroster outlet 48 is configured to distribute conditioned airflows to the windshield. The front face outlet 50 is configured to distribute conditioned airflows to upper side of a driver seat 57. The front foot outlet 52 is configured to distribute conditioned air to lower side of the driver seat 57. The rear face outlet 54 is configured to distribute conditioned airflows to upper side of a rear passenger seat 59. The rear foot outlet 56 is configured to distribute conditioned air to lower side of the rear passenger seat 59.

The fist blower 16 is located on a downstream side of the ambient air inlet 20 and the first recirculation air inlet 22, and upstream side of the evaporator 12. In this embodiment, the second blower 18 is located in downstream side the evaporator 12. However, in another embodiment, the second blower may be located in upstream side of the evaporator 12 in parallel with the first blower 16. The second blower 18 is configured to intake airflows from downstream side of the evaporator 12 or downstream side of the heating heat exchanger 14.

The plurality of doors may further include air-mixing doors. In this embodiment, there are two air-mixing doors 58 and 60. The air-mixing door 58 is located in the front air passage 44, and the other air-mixing door 60 is located in the rear air passage 46. The air-mixing doors 58, 60 may adjust the ratio between an airflow bypassing the heating heat exchanger 14 and an airflow passed through the heating heat exchanger 14, in order to adjust the temperature of the conditioned air. In this embodiment, the air-mixing door 58 located in the front air passage 44, is a slide type door. The slide type air-mixing door 58 is actuated by a pinion gear 58a.

Additionally, the plurality of doors may further include front distribution mode doors 66a-66c (not shown in FIG. 1) and a rear distribution mode door 43. The front distribution mode doors 66a-66c open and close each of the defroster outlet 48, the front face outlet 50, and the front foot outlet 52. The rear distribution mode door 43 is disposed in the rear air passage 46, and adjusts the flow ratio between an airflow delivered to the rear face outlet 54 and an airflow delivered to the rear foot outlet 56.

The air-conditioning apparatus 2 further comprises a first thermistor Th1, a second thermistor Th2, and an electronic controller unit (ECU). The first thermistor Th1 is configured to detect the temperature of the evaporator 12 in the rear air passage 46. The second thermistor Th2 is configured to detect the temperature of the evaporator 12 in the front air passage 44. The ECU is operatively connected to the first and the second thermistors Th1, Th2, the intake mode switching door 27, and the compressor 28. The ECU receives various inputs from sensors 62 and switches 64 of the air-conditioning apparatus 2.

The ECU controls the air-conditioning case 10 to switch the air intake mode from the double-layered air intake mode to the ambient air intake mode, when an evaporator temperature detected by the first thermistor Th1 falls below a first threshold value. The ECU stops the compressor 28 when the evaporator temperature detected by the second thermistor Th2 falls below a second threshold value.

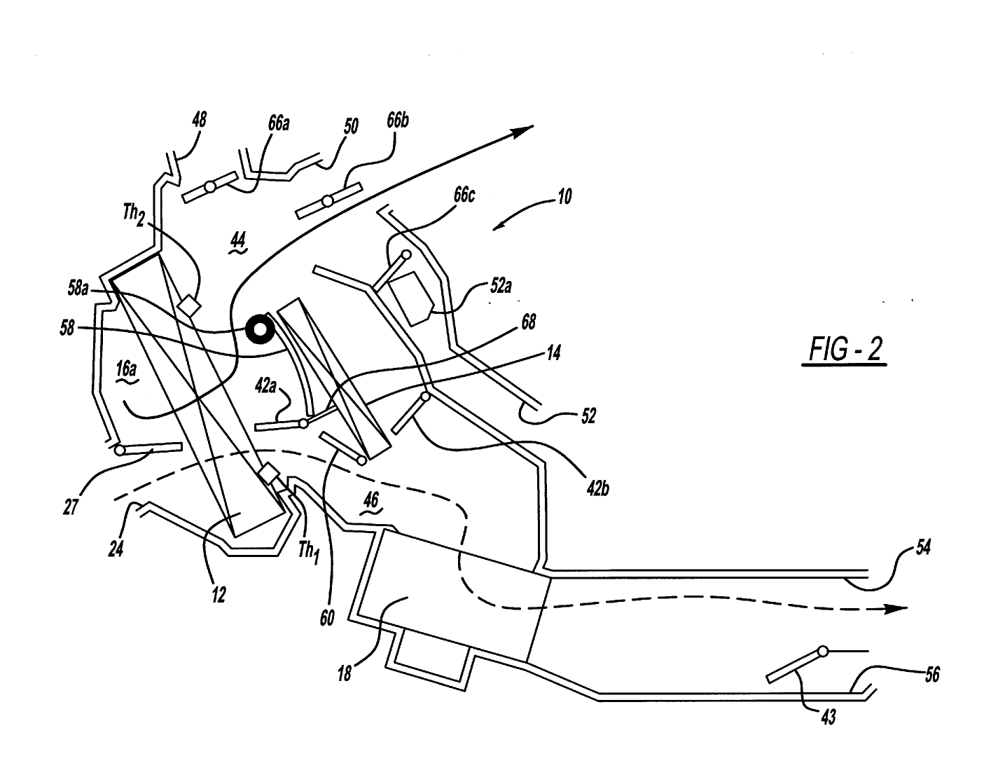

FIG. 2 is a cross sectional view showing detailed shape of the air conditioning case 10 distributing the conditioned air to upper side of front and rear seats in the double-layered air intake mode. FIG. 2 shows front distribution mode doors 66a, 66b, and 66c. The front defroster door 66a opens and closes defroster outlet 48. The front face door 66b opens and closes front face outlet 50. The front foot door 66c opens and closes front foot outlet 52. FIG. 2 also shows an additional front foot outlet 52a. The front foot door 66c is disposed upstream side of the additional front foot outlet 52a, thus, the front foot door 66c can control not only the airflow amount into the front foot outlet 52, but also the airflow amount into the additional front foot outlet 52a. Yet, the reference numeral 16a indicates an area, where the airflow created by the first blower 16 flown in.

FIG. 2 shows the air conditioning case 10 in the double-layered mode. In the double-layered mode, the intake mode switching door 27 opens the second recirculation air inlet 24, and the ambient-recirculation air switching door 25 opens the ambient air inlet 20. In the double-layered mode, the mode switching door 27 separates airflows coming from the second recirculation air inlet 24 from the airflow coming from ambient air inlet 20. The mode switching door 27, the rear airflow amount control doors 42a, 42b and the air-mixing door 60 constitutes a part of the dividing wall 68. Thus, there are two separated inlets and airflow paths in the air conditioning case 10. Yet, the first recirculation air inlet 22 is closed by the ambient-recirculation air switching door 25.

FIG. 2 also shows the positions of two air-mixing doors 58 and 60. The air-mixing doors 58 and 60 prevent airflows from passing through the heating heat exchanger 14. FIG. 2 also shows face distribution mode. In the face distribution mode, the air conditioning case 10 distributing the conditioned air to upper side of front and rear seats. In the face distribution mode, the front defroster door 66a closes defroster outlet 48, the front face door 66b opens front face outlet 50, and the front foot door 66c closes front foot outlet 52. Yet, in the face distribution mode, the rear distribution mode door 43 opens the rear face outlet 54, and closes rear foot outlet 56.

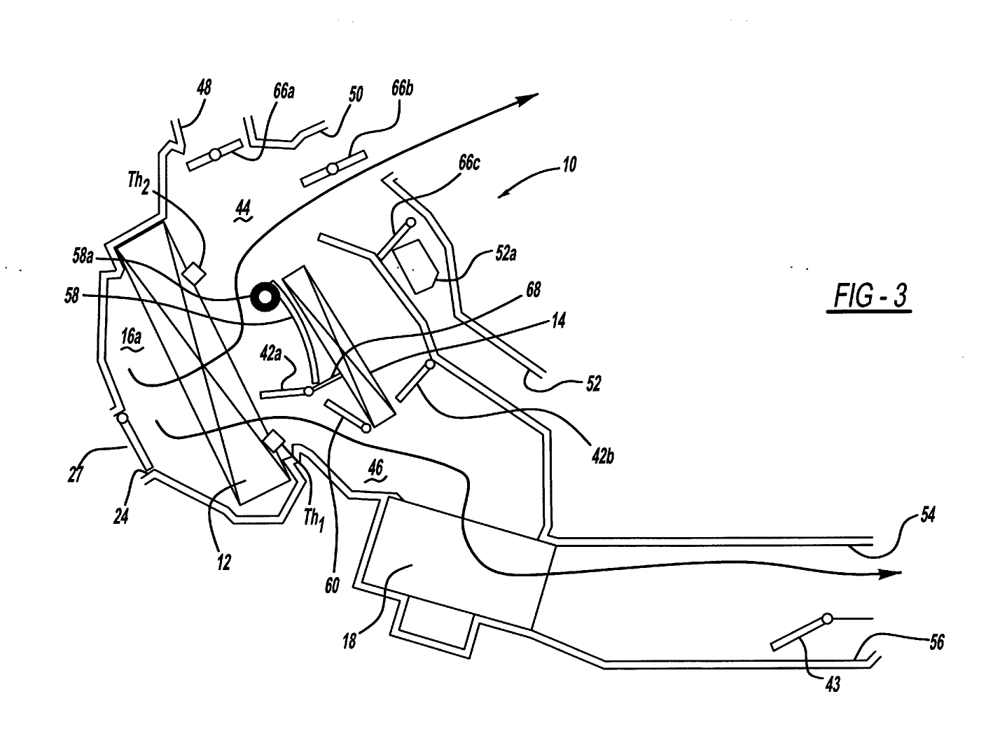

FIG. 3 shows the air conditioning case 10 in the ambient air intake mode. In the ambient air intake mode, the intake mode switching door 27 closes the second recirculation air inlet 24, and the ambient-recirculation air switching door 25 opens the ambient air inlet 20. In this mode, the airflow coming from the ambient air inlet 20 is split into two airflows. Since the distribution mode and positions of the air-mixing doors 58 and 60 in FIG. 3 is the same as the distribution mode in FIG. 2, both air flows are bypassing the heating heat exchanger 14, and one of the two airflows is flown into front face outlet 50, while the other one of the two airflows is flown into rear face outlet 54. Yet, the first recirculation air inlet 22 is closed by the ambient-recirculation air switching door 25.

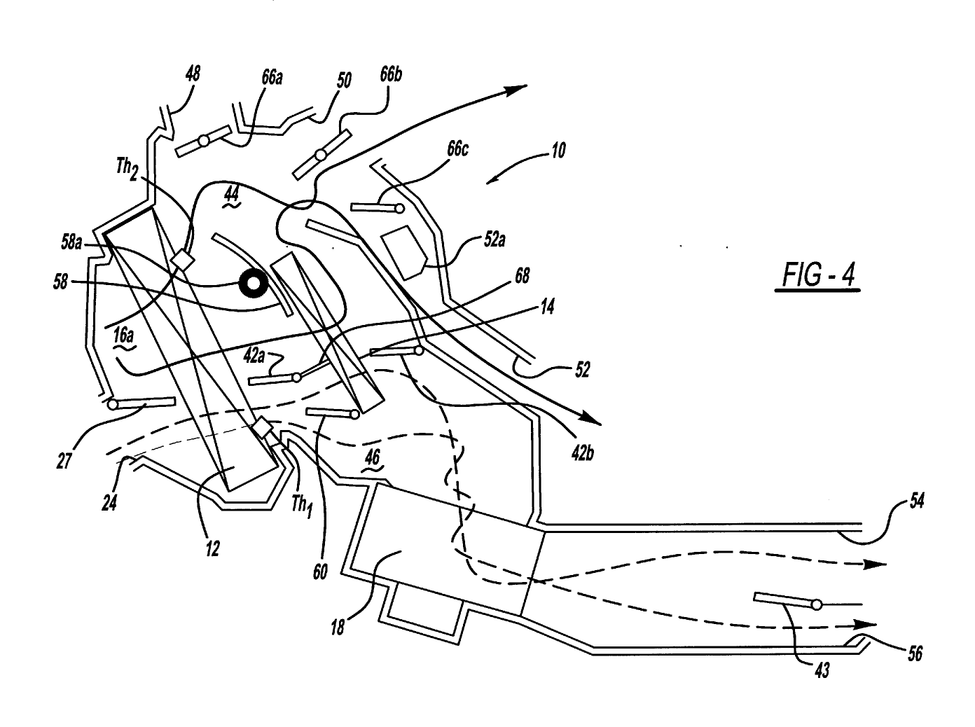

FIG. 4 is a cross sectional view showing detailed shape of the air conditioning case distributing the conditioned air to upper and lower side of seats in the double-layered air intake mode. FIG. 4 shows the air conditioning case 10 in the double-layered mode same as FIG. 2. FIG. 4 also shows the positions of two air-mixing doors 58 and 60.

The air-mixing door 58 splits airflow from the ambient air inlet 20. One of the split airflows bypasses the heating heat exchanger 14, and the other airflow passes through the heating heat exchanger 14. Also, the air-mixing door 60 splits airflow from the second recirculation air inlet 24. One of the airflows by passes the heating heat exchanger 14, and the other passes through the heating heat exchanger 14.

FIG. 4 also shows bi-level distribution mode. In the bi-level distribution mode, the air conditioning case 10 distributes the conditioned air to upper side and lower side of front and rear seats. In the bi-level distribution mode, the front defroster door 66a closes defroster outlet 48, the front face door 66b opens front face outlet 50, and the front foot door 66c opens front foot outlet 52. Yet, in the bi-level mode, the rear distribution mode door 43 opens the rear face outlet 54, and rear foot outlet 56.

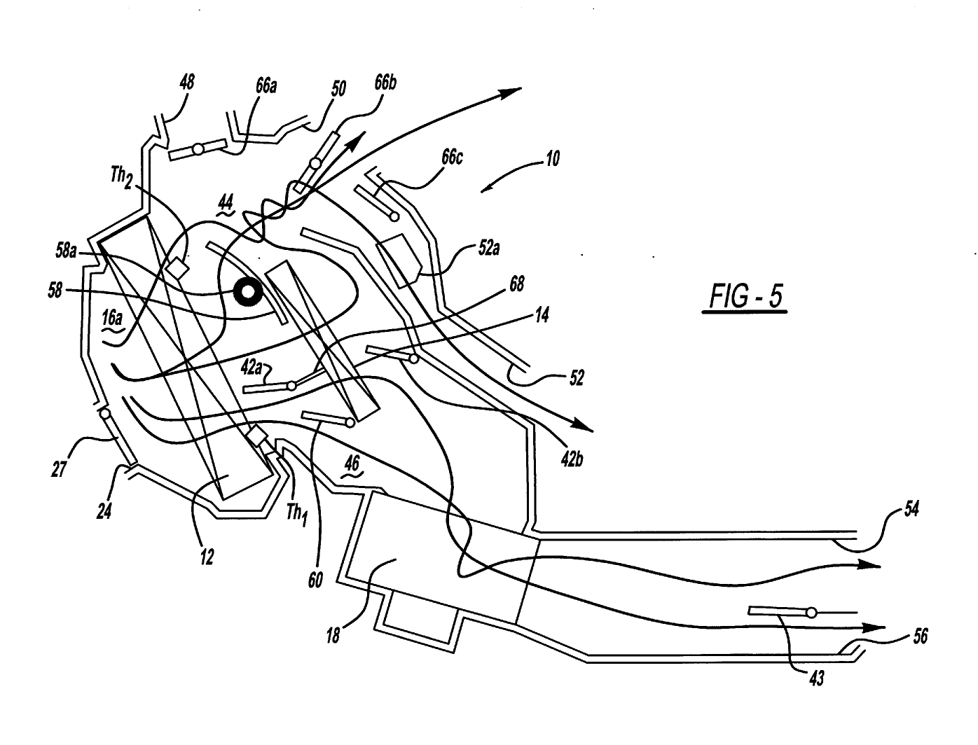

FIG. 5 is a cross sectional view showing detailed shape of the air conditioning case distributing the conditioned air to upper and lower side of seats in the ambient air intake mode. The ambient air intake mode is the same as FIG. 3. The distribution mode and positions of the air-mixing doors 58 and 60 in FIG. 5 is the same as the distribution mode in FIG. 4.

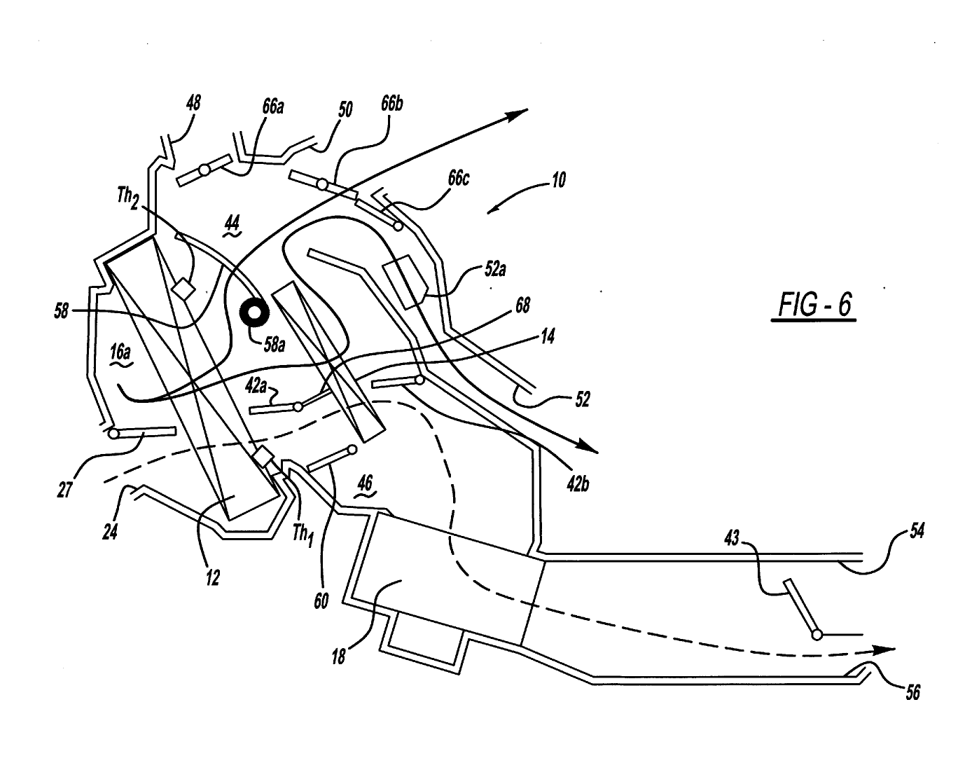

FIG. 6 is a cross sectional view showing detailed shape of the air conditioning case distributing the conditioned air to the lower side of seats in the double-layered air intake mode. FIG. 6 shows the air conditioning case 10 in the double-layered mode same as FIG. 2. FIG. 6 also shows the positions of two air-mixing doors 58 and 60.

The air-mixing doors 58 and 60 prevent airflows from bypassing the heating heat exchanger 14. FIG. 6 also shows foot distribution mode. In the foot distribution mode, the air conditioning case 10 distributes the conditioned air to lower side of front and rear seats. In the foot distribution mode, the front defroster door 66a closes defroster outlet 48, the front face door 66b closes front face outlet 50, and the front foot door 66c opens front foot outlet 52. Yet, in the foot mode, the rear distribution mode door 43 opens the rear foot outlet 56, and closes the rear face outlet 54.

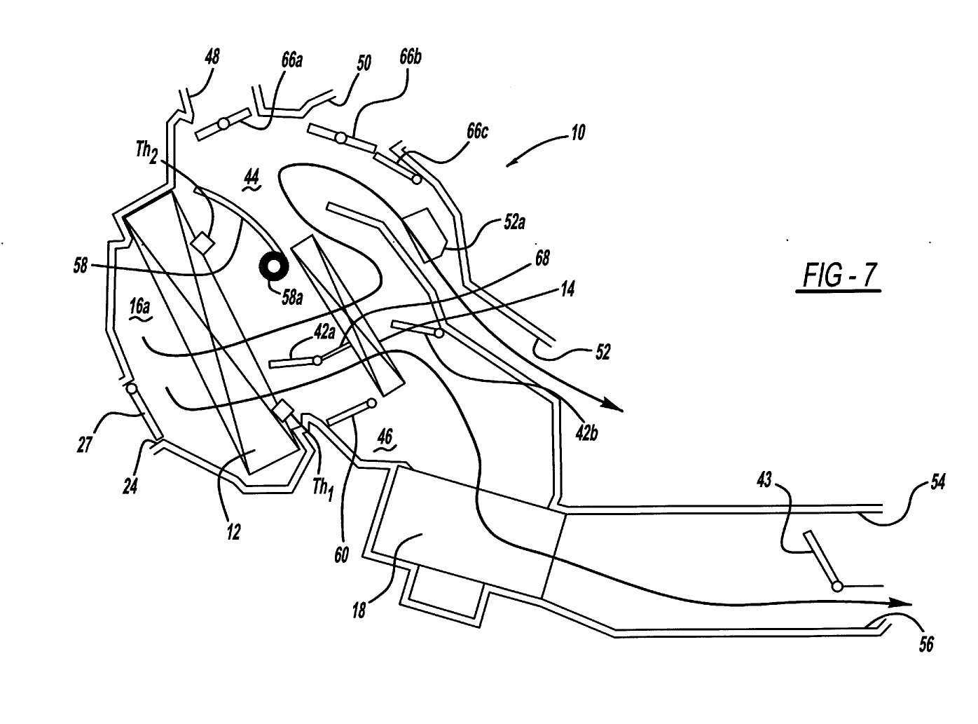

FIG. 7 is a cross sectional view showing detailed shape of the air conditioning case distributing the conditioned air to lower side of seats in the ambient air intake mode. The ambient air intake mode is the same as FIG. 3. The distribution mode and positions of the air-mixing doors 58 and 60 in FIG. 7 is the same as the distribution mode in FIG. 6.

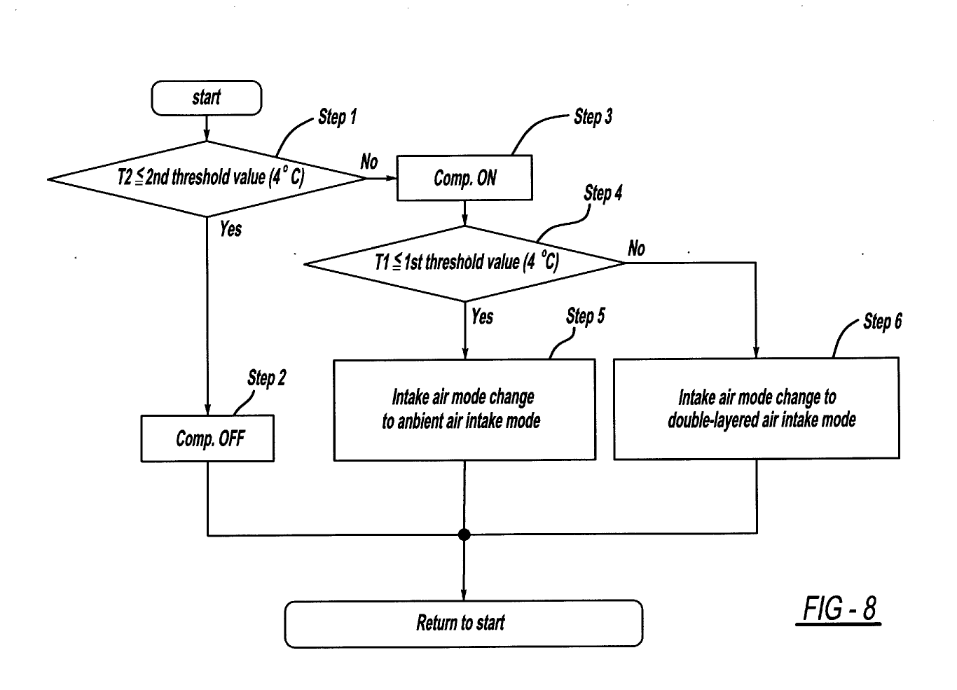

FIG. 8 is a flowchart depicting a control method operated by the ECU for the air-conditioning case 10 in the present disclosure. T1 represents airflow temperature detected by the thermistor T1. T2 represents airflow temperature detected by the thermistor T2. In step 1, the ECU determines if the T2 is less than or equal to a second threshold value (in this embodiment, the second threshold value is 4° C.). If the T2 is less than or equal to the second threshold value, the method moves to Step 2, otherwise, the method moves to Step 3. In Step 2, the ECU stops the compressor 28, then the method returns to Step 1. In Step 3, the ECU turns on the compressor 28, and then the method moves to Step 4. In Step 4, the ECU determines if the T1 is less than or equal to the first threshold value (in this embodiment, the first threshold value is also 4° C.). If the T1 is less than or equal to the first threshold value, the method moves to Step 5, otherwise, the method moves to Step 6. In step 5, the ECU switches intake air mode to the ambient air intake mode (depicted in FIGS. 3, 5, and 7), and then, the method returns to Step 1. In step 6, the ECU switches intake air mode to the double-layered air intake mode (depicted in FIGS. 2, 4, and 6), and then, the method returns to Step 1.

By the controlling method explained above, the ECU may stop recirculating cabin air, and may introduce ambient air when the evaporator is about to frost in the double-layered air intake mode. The ambient air may be less humid or high temperature. Thus, the evaporator 12 may be prevented from frosting by this controlling method.

Yet, by the controlling method explained above, the ECU may stop the compressor when the evaporator is about to frost in the double-layered air intake mode.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the Figures. Spatially relative terms may be intended to encompass different orientations of the device in use or operation in addition to the orientation depicted in the Figures. For example, if the device in the Figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. An air-conditioning apparatus for a vehicle cabin comprising:
an air-conditioning case defining a plurality of air intake modes, the plurality of air intake modes includes an ambient air intake mode mainly introducing ambient air from an outside of the vehicle cabin, and a double-layered air intake mode simultaneously introducing the ambient air and recirculation air from an inside of the vehicle cabin;
an evaporator accommodated in the air-conditioning case;
a first thermistor configured to detect the temperature of the evaporator, and
a controller for controlling the air-conditioning case,
wherein
the double-layered air intake mode supplies ambient air to a front side of the vehicle cabin via a front air passage, and supplies a recirculation air from the vehicle cabin to the rear side of the vehicle cabin via a rear air passage, and
the controller controls the air-conditioning case to switch the air intake mode from the double-layered air intake mode to the ambient air intake mode, when an evaporator temperature detected by the first thermistor falls below a first threshold value.

2. An air-conditioning apparatus according claim 1, further comprising
a second thermistor configured to detect temperature of the evaporator in the front air passage,
wherein,
the first thermistor is configured to detect temperature of the evaporator in the rear air passage, and
the controller stops a compressor, which constitutes a refrigeration cycle with the evaporator, when the evaporator temperature detected by the second thermistor falls below a second threshold value.

3. An air-conditioning apparatus according claim 1, wherein the rear air passage supplies the recirculation to an upper part of a rear passenger seat.

4. An air-conditioning apparatus according to claim 1 further comprising:
a first blower configured to provide airflow in the air-conditioning case, and
a second blower configured to provide airflow in the rear air passage,
wherein, the air-conditioning case defines a dividing wall, which divides the front air passage and the rear air passage, and a part of the dividing wall moves when the controller controls the air-conditioning case to switch the air intake mode.

5. An air-conditioning apparatus according to claim 4 further comprising:
a heating heat exchanger accommodated in the air-conditioning case, the heating heat exchanger penetrates the dividing wall, and
a pair of air-mixing doors disposed between the evaporator and the heating heat exchanger
wherein,
one of the air-mixing doors is disposed in the front air passage, and the other one of the air-mixing doors is disposed in the rear air passage.
